(19) United States
(12) Patent Application Publication
(10) Pub. No.: US 2017/0295424 A1
(43) Pub. Date: Oct. 12, 2017

(54) SOUND GENERATING DEVICE

(71) Applicant: BEIJING TAIHE KAIYUAN TECHNOLOGIES CORPORATION, BEIJING (CN)

(72) Inventor: YUGONG YANG, Beijing (CN)

(21) Appl. No.: 15/632,256

(22) Filed: Jun. 23, 2017

Related U.S. Application Data
(63) Continuation of application No. PCT/CN2015/085540, filed on Jul. 30, 2015.

(30) Foreign Application Priority Data
Dec. 23, 2014 (CN) 201410816100.1
Dec. 23, 2014 (CN) 201410816121.3

(51) Int. Cl. H04R 1/20; H04R 1/28; H04R 9/06

(52) U.S. Cl. CPC H04R 1/20; H04R 9/06; H04R 1/2803

(57) ABSTRACT

A sound generating device, comprising a shell structure having a gap between the inside and outside, wherein a first hole (22a) and a second hole (23a) opposite to each other are provided on inner shell (2a); a sound source (3) is fixed inside the first hole (22a), and a front side (31) thereof faces towards an outer shell (1a), and a back side (32) thereof faces towards the second hole (23a); a third hole (12a) opposite the first hole (22a) is provided on the outer shell (1a), and spaced apart from the sound source (3) by a distance; a backward sound wave of the sound source (3) passes through the second hole (23a) and enters into the gap, and exits from the third hole (12a) together with a forward sound wave of the sound source (3).

### CROSS-REFERENCE TO RELATED APPLICATIONS

This application is a continuation of International Application No. PCT/CN2015/085540, filed on Jul. 30, 2015, which claims the priority benefits of China Patent Application Nos. 201410816100.1 and 201410816121.3, filed on December 23, 2014. The contents of the above identified applications are incorporated herein by reference in their entireties.

### FIELD OF THE TECHNOLOGY

The present invention relates to the technical field of acoustics, and particularly to a sound generating device.

### BACKGROUND

A traditional sound generating device, such as a loudspeaker, is a sound generating device with low sound generating efficiency, and the increase of the sound generating efficiency can be improved by setting it in a sound enclosure. The theoretical basis of the conventional sound enclosure design is Infinite Baffle theory, namely, placing an infinite baffle between the forward and backward sound waves of the loudspeaker diaphragm to block the forward and backward sound waves and thereby avoid offset each other in the air. However, since it is impossible to make the infinite baffle infinitely great, in order to block the backward sound wave of the loudspeaker and release energy of the forward sound wave of the loudspeaker, the infinite baffle is rolled towards the direction of the backward sound wave of the loudspeaker to form a closed space, resulting in a modern sound enclosure.

Due to the structure design of the modern sound enclosure is based on the infinite baffle theory, and the design point is inhibiting the backward sound wave of the loudspeaker, namely, shielding the energy of the backward sound wave of the loudspeaker by a closed sound enclosure, which causes loss of sound generating energy of the loudspeaker, the modern sound enclosure has very low sound generating energy and efficiency.

### SUMMARY

A first aspect of the invention is to provide a sound generating device, comprising an outer shell, an inner shell, a sound source, wherein the inner shell is disposed inside the outer shell, and a gap is formed between an outer surface of the inner shell and an inner surface of the outer shell;

the inner shell is provided with a first hole and a second hole opposite to each other; the sound source is fixed inside the first hole, and a front side of the sound source faces towards the outer shell, and a back side of the sound source faces towards the second hole;

the outer shell is provided with a third hole opposite to the first hole, and the third hole is spaced apart from the sound source by a distance; a backward sound wave of the sound source passes through the second hole and enters into the gap, and exits from the third hole together with a forward sound wave of the sound source.

Another aspect of the invention is to provide a sound generating device comprising: a shell, a sound source, at least one guide plate;

wherein the shell is provided with a fifth hole and at least one sixth hole, the sound source is fixed within the fifth hole, and the sixth hole is distributed around the fifth hole within a preset range;

each guide plate is arranged on an inner surface of the shell on the same side of the sound source, and one end of the guide plate is connected with the shell, and the other end thereof is a free end, so that backward sound wave of the sound source bypasses the free end of the guide plate and exits from the sixth hole.

The sound generating device of the invention as described above has an inner-outer shell structure, and the sound source is arranged in the sound generating device having the inner-outer shell structure, which makes the backward sound wave of the sound source pass through the hole provided on the inner shell and enter the gap between the inner shell and the outer shell, and then exit, together with the forward sound wave of the sound source, from the hole of the outer shell, providing an unobstructed propagation path for the backward sound wave of sound source. Another sound generating device of the invention as described above, wherein the guide plate is disposed in the shell accommodating the sound source, and one end of the guide plate is disposed on the inter surface of the shell on the same side of the sound source, and the other end of the guide plate is a free end, so that the backward sound wave emitted by the sound source could bypass the free end of the guide plate and exit from the sixth hole preseted on the shell, and the sixth holes is located around the sound source in a preset range, such a sound generating device can provide an unobstructed propagation path for the backward sound wave of sound source. The sound source can be a loudspeaker, a drum membrane, or a sound board, or other sound generating body; the above two kinds of sound generating devices completely subvert the design idea of the infinite baffle of traditional sound generating devices (such as sound enclosure), i.e., the design idea of isolating the backward sound wave of the sound source, and thereby realizes effective utilization of the backward sound wave of the sound source by contrarily changing the direction of the backward sound wave and producing a physical effect with the forward sound wave of the sound source, thus the acoustic performance of the sound source is improved, and the sound generating energy and electroacoustic efficiency of the sound source are greatly improved, bringing about a great practical value.

### BRIEF DESCRIPTION OF THE DRAWINGS

FIG. 1 is a structure diagram of a sound generating device provided by Embodiment 1 of the present invention;

FIG. 2 is a structure diagram of a sound generating device with a cube structure provided by Embodiment 2 of the present invention;

FIG. 3 is a structure diagram of a sound generating device with a sphere structure provided by Embodiment 2 of the present invention;

FIG. 4a and FIG. 4b are structure diagrams of a sound generating device having different inner and outer shell shapes provided by Embodiment 2 of the present invention;

FIG. 5 is a structure diagram of a partial tone plate of a sound generating device provided by Embodiment 2 of the present invention;

FIG. 6 is a structure diagram of another sound generating device provided by Embodiment 3 of the present invention;

FIG. 7 is a structure diagram of another sound generating device provided by Embodiment 4 of the present invention;

FIG. 8 is a structure diagram of a partial tone plate of another sound generating device provided by Embodiment 4 of the present invention;

FIG. 9 is a structure diagram of multiple sound sources of another sound generating device provided by Embodiment 4 of the present invention;

FIG. 10 is a structure diagram of a sound generating device with a barrel structure provided by Embodiment 2 of the present invention;

FIG. 11 is a top view of the sound generating device shown in FIG. 10.

Description of reference numbers are as follows:

1a, outer shell; 2a, inner shell; 3, sound source; 4, partial tone cone; 5, partial tone plate; 6a, partition plate; 7, guide sheet; 8, guide block; 11a, inner surface of the outer shell; 12a, third hole; 13a, fourth hole; 21a, outer surface of the inner shell; 22a, first hole; 23a, second hole; 24a, inner surface of the inner shell; 31, front side of the sound source; 32, back side of the sound source; 41, conical tip of the partial tone cone; 42, conical side surface; 51, rib; 52, center of the partial tone plate; 1b, shell; 2b, guide plate; 11b, fifth hole; 12b, sixth hole; 13b, inner surface; 21b, free end; 131b, inner surface of the shell on the same side as the sound source; 132b, inner surface of the shell facing the back side of the sound source

### DETAILED DESCRIPTION

In order to make objects, technical solutions and advantages of the present invention clearer, technical solutions of embodiments of the present invention are described clearly and completely with reference to the accompanying drawings. It should be noted that similar or identical element is marked with the same reference number in the drawings or the description.

### Embodiment 1

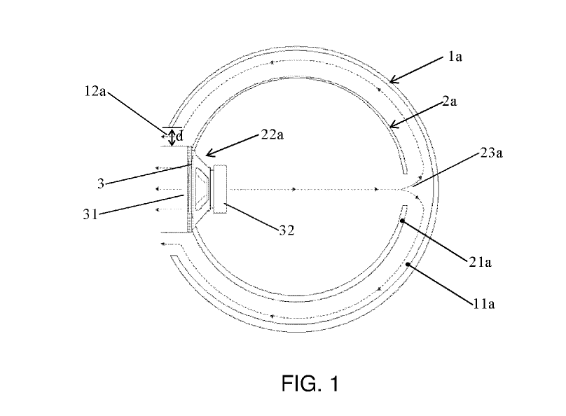

FIG. 1 is a structure diagram of a sound generating device provided by Embodiment 1 of the present invention. As shown in FIG. 1, a sound generating device provided by the present invention comprises: an outer shell 1a, an inner shell 2a, a sound source 3, wherein the inner shell 2a is provided inside the outer shell 1a, a gap is formed between an outer surface 21a of the inner shell 2a and an inner surface 11a of the outer shell 1a; a first hole 22a and a second hole 23a are provided opposite to each other on the inner shell 2a; the sound source 3 is fixed inside the first hole 22a, and a front side 31 of the sound source 3 faces towards the outer shell 1a, and a back side 32 of the sound source 3 faces towards the second hole 23a; a third hole 12a opposite to the first hole 22a is provided on the outer shell 1a, and is spaced apart from the sound source 3 by a distance d; a backward sound wave of the sound source 3 passes through the second hole 23a and enters into the gap, and exits from the third hole 12a together with a forward sound wave of the sound source 3.

It should be noted that, the sound generating device of the present invention can be applied to any sound generating device having the structure described in the present invention, for example, a sound enclosure, an earphone or a musical instrument. The following embodiments are illustrated by taking the sound enclosure as an example. The sound source can be a loudspeaker, a drum membrane, or a soundboard or any other sound generating body. The following embodiments are all taken a loudspeaker as an example of the sound source.

Specifically, when vibrating, the loudspeaker diaphragm emits sound waves towards the forward and backward respectively. The two-way sound waves have opposite “phase”. The so-called opposite “phase” is that at any moment of vibration displacement of the diaphragm, the waveforms of the two-way sound waves are exactly offset each other, which results in a “short circuit” phenomenon of the two-way sound waves of the diaphragm in the air. The sound of a bare speaker is often meager, stiff and narrow, which is a manifestation of the sound “short circuits”. Then the sound enclosure is born, and the essence thereof is to play the efficiency of the loudspeaker, design principle thereof is based on the “infinite baffle” theory, namely, isolating the backward sound wave of the loudspeaker diaphragm from the forward sound wave of the loudspeaker diaphragm, and the theoretical model thereof is that placing an infinite baffle between the forward and backward sound waves of the loudspeaker diaphragm, to isolate the backward and forward sound waves and thereby avoid offset each other in the air. However, since it is impossible to make the infinite baffle infinitely great, the infinite baffle is rolled towards the direction of the backward sound wave of the loudspeaker to form a closed space, which is the theoretical basis of modern sound enclosure design.

The modern sound enclosure is generally divided into three categories, i.e., closed box type sound enclosure, bass reflex type sound enclosure, and transmission line type sound enclosure, wherein the closed box type sound enclosure is using a closed space to completely isolate the transmission of the backward sound wave of the loudspeaker; the bass reflex type (also called inverted phase type) sound enclosure is using multiple reflections of the backward sound wave of the loudspeaker on the inner wall of the box to form an oscillatory wave, and using a resonance effect of an inverted tube to enhance a bass effect of the loudspeaker. However, since a loudspeaker is generally sounded towards both forward direction and backward direction, in the case of the inverted phase type sound enclosure, such working mode will inhibit the backward sound wave and convert the backward sound wave into a resonance wave for output, which only emphasizes low frequency sound waves having no information analysis ability. Transmission line type sound enclosure, also called as labyrinth type sound enclosure, is continuously weakening energy of the backward sound wave of the loudspeaker by setting in the sound enclosure a tortuous channel with a shrinking diameter and filled with a sound-absorbing material, to obtain good low frequency response. No matter which kind of sound enclosure, they are all based on the fact that backward sound generating energy of the loudspeaker diaphragm is shielded or the backward sound wave of the loudspeaker is inhibited, so there is a problem that electroacoustic conversion efficiency of the loudspeaker is low. The loudspeaker diaphragm can equally emit sound waves backward and forward, and according to the infinite baffle theory, the forward sound wave is an effective energy, while the backward sound wave is an ineffective and harmful energy and thus the forward sound wave can be used, the backward sound wave must be inhibited. Theoretically, electroacoustic conversion efficiency of the loudspeaker is unlikely to exceed 50%. Due to the fact that inhibition of the backward sound wave can interfere with performance of the forward sound wave, electro-acoustic conversion efficiency of the sound enclosure will be lower and with the improvement of power, electro-acoustic conversion efficiency of the sound enclosure has a tendency to gradually decline. A direct performance of low electroacoustic conversion efficiency is poor sound analysis and frequency response, and narrow frequency response range.

However, the present invention abandons the traditional technical prejudice and gives a structural design wherein the backward sound wave of the loudspeaker is reversely formed into a “forward” sound wave while remaining its original characteristics, and produces a physical effect with the original forward sound wave of the loudspeaker, so as to form very fine sound particles with full frequency performance Such structural design comprehensively surpasses the traditional sound enclosure design in sound reduction degree, sound field fidelity and box off feeling and other high fidelity indices.

The sound generating device shown in FIG. 1 has a double shell structure comprising an outer shell 1a and an inner shell 2a, wherein the inner shell 2a is provided inside the outer shell 1a, a gap is formed between the inner shell and the outer shell and is a propagation path of the backward sound wave that has been reversed to a forward sound wave of a sound source 3, such as a loudspeaker; a first hole 22a and a second hole 23a opposite to each other are provided on the inner shell 2a, wherein the sound source 3 is fixed within the first hole 22a, a front side 31 of the sound source 3 faces towards the outer shell 1a, and a forward sound wave of the sound source 3 radiates from the front side 31 to the outside; a back side 32 of the sound source 3 faces towards the second hole 23a, a third hole 12a opposite to the first hole 22a is provided on the outer shell 1a and spaced apart from the sound source 3 by a distance d; a backward sound wave of the sound source 3 passes through the second hole 23a and enters into the gap, and exits from the third hole 12a together with the forward sound wave of the sound source 3. Thus the backward sound wave of the sound source 3 sequentially passes through a channel formed by the second hole 23a, the gap between the inner shell and the outer shell, and the third hole 12a, and is smoothly reversed to a forward sound wave, and then produces a physical effect of energy enhancement with original forward sound wave of the sound source 3.

In the sound generating device of the present embodiment, by arranging the sound source in the sound generating device with an inner-outer shell structure, the backward sound wave of the sound source may pass through the hole provided on the inner shell and enter the gap between the inner shell and outer shell, and then exits from the holes provided on the outer shell together with the forward sound wave of the sound source, thereby providing an unobstructed propagation path for the backward sound wave of the sound source. Such sound generating device completely subverts a design idea of the infinite baffle of a traditional sound generating device (such as a sound enclosure), i.e., a design idea of isolating the backward sound wave of the sound source, and thereby realizes effective utilization of the backward sound wave of the sound source by contrarily changing the direction of the backward sound wave and producing a physical effect with the forward sound wave of the sound source, thus the acoustic performance of the sound source, such as a loudspeaker, a drum membrane, a soundboard or other sound generating body, is improved, such as, sound generating energy and electroacoustic efficiency of the loudspeaker, sound generating efficiency of the drum membrane or soundboard, are greatly improved, bringing about a great practical value.

### Embodiment 2

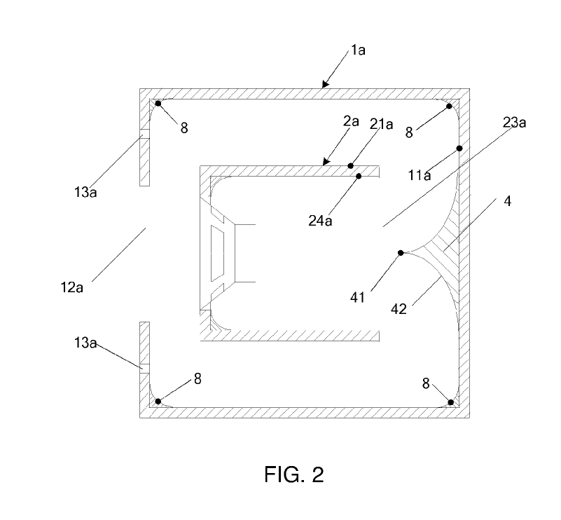

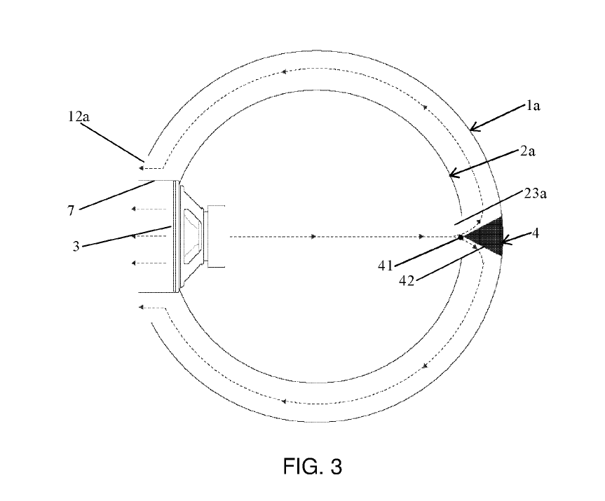

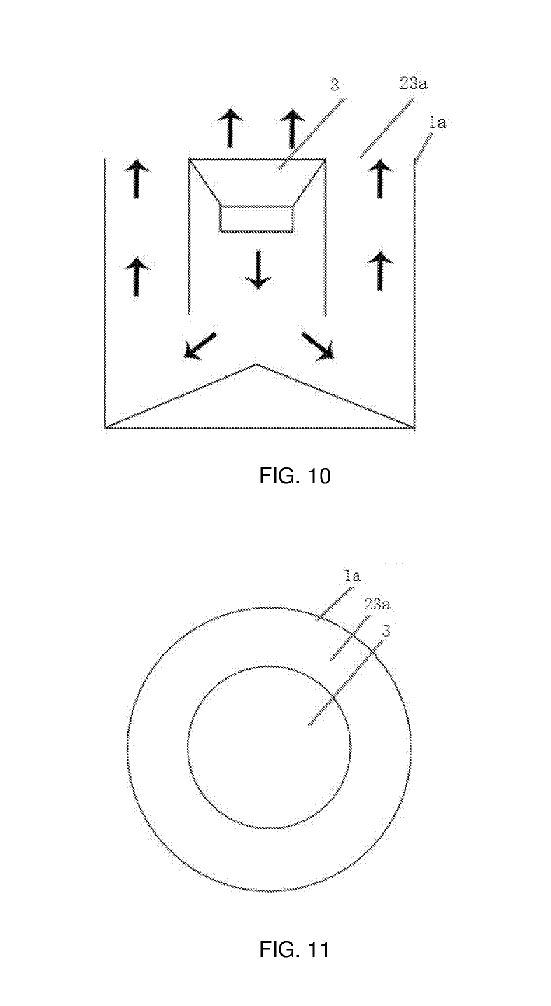

FIG. 2 is a structure diagram of a sound generating device with a cube structure provided by Embodiment 2 of the present invention. As shown in FIG. 2 the present invention provides a sound generating device based on Embodiment 1, wherein the inner shell 2a has the same shape as the outer shell 1a; both the inner shell 2a and the outer shell 1a are polyhedral, and gravity centers of the inner shell 2a and the outer shell 1a are overlapped, and as shown in FIG. 2, the inner shell 2a and the outer shell 1a may have such as a cube structure; or, as shown in FIG. 3 which is a structure diagram of a sound generating device with a sphere structure provided by Embodiment 2 of the present invention, the inner shell 2a and the outer shell 1a are spheres, and sphere centers of the inner shell 2a and the outer shell 1a are overlapped. FIG. 10 is a structure diagram of a sound generating device with a barrel structure provided by Embodiment 2 of the present invention, wherein the inner shell 2a and the outer shell 1a are barrels, and centers of the inner shell 2a and the outer shell 1a are overlapped. FIG. 11 is a top view of the sound generating device shown in FIG. 10.

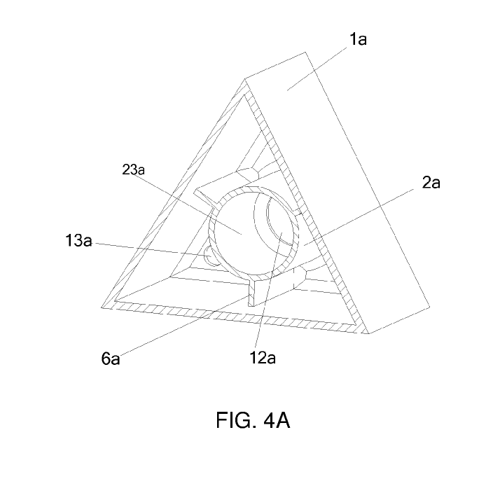

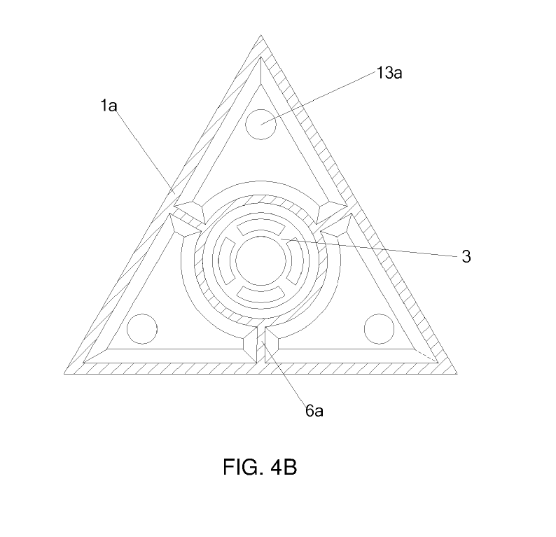

Specifically, if the inner shell and the outer shell have the same shape, then the gap between the inner shell and the outer shell can be made uniform by overlapping gravity center of the inner shell with that of the outer shell, thereby a forward sound wave formed by the backward sound wave of the loudspeaker after reversing maintains 360 degree uniform sound generating energy in the uniform gap, so that the backward sound wave exited from the third hole 12a has uniform sound volume and the sound effect, and high sound quality. Additionally, the gravity centers of the inner shell and the outer shell can also be offset from each other, and the shapes of the inner shell and the outer shell can be varied. For example, the inner shell and the outer shell may have a cube structure as shown in FIG. 2, i.e., the inner shell 2a and the outer shell 1a are cubical, and have an overlapped gravity center; or the inner shell and the outer shell have a sphere structure as shown in FIG. 3, i.e., the inner shell 2a and the outer shell 1a are spherical, and have an overlapped gravity center; or the inner shell and the outer shell may be cylindrical, six prismatic, square, or three prismatic and so on. FIGS. 4a, 4b are structure diagrams of a sound generating device having different inner and outer shell shapes provided by Embodiment 2 of the present invention, wherein FIG. 4a is a sectional view of back side of sound source of the sound generating device, and it can be seen that the inner shell 2a inside the sound generating device is a cylinder, and the outer shell 1a is a three prism.

The sound generating device further comprises a partial tone cone 4, the partial tone cone 4 has a cone structure and is fixed on an inner surface 11a of the outer shell 1a, and conical tip 41 of the partial tone cone 4 is opposite to the second hole 23a. The partial tone cone 4 may reduce direct collision of the backward sound wave with the inner surface 11a of the outer shell 1a, reduce the probability of vertical reflection and thereby reduce interference on the original sound wave waveform so that the backward sound wave can smoothly flow along the conical tip 41 of the partial tone cone 4 into a guide channel of the backward sound wave and preserve the original waveform characteristics of the backward sound wave to a maximum extent, to make the backward sound wave in the form of closest to the original state meet the forward sound wave and produce a high energy physical effect. In order to further reduce reflection of the backward sound wave, prevent generation of a standing wave and meanwhile remain complete sound wave characteristics as far as possible, conical side surface 42 of the partial tone cone 4 is designed to be a concave conical side surface 42.

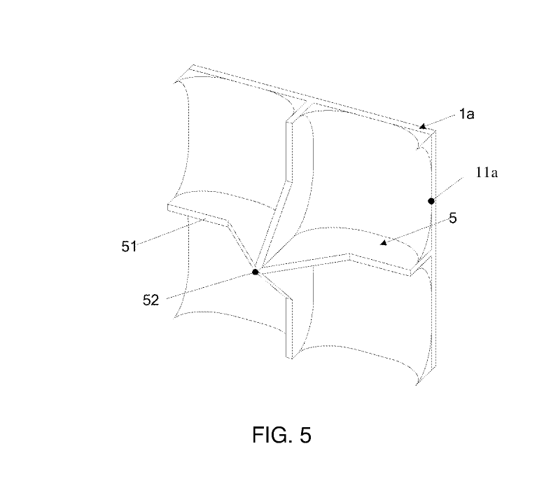

In addition, the sound generating device may further comprise (as shown in FIG. 5, FIG. 5 is a structure diagram of a partial tone plate of a sound generating device provided by

Embodiment 2 of the present invention): a partial tone plate 5, which has the same function as the partial tone cone 4, i.e., making sound wave more smoothly enter into a reverse channel of the sound wave. The partial tone plate 5 is a star shaped rib 51 and is fixed on the inner surface 11a of the outer shell 1a, and a center 52 of the partial tone plate 5 is opposite to the second hole 23a, and the rib 51 of the partial tone plate 5 faces towards the second hole 23a. In order to further reduce the reflection of the backward sound wave and prevent generation of a standing wave, and meanwhile maintain complete sound wave characteristics as far as possible, the rib 51 of the partial tone plate 5 can be designed as a concave structure.

Further, a fourth hole 13a is provided on the outer shell 1a corresponding to the gap between the inter shell and outer shell, and is distributed within a preset range around the third hole 12a, or at least one gap partition plate 6a (as shown in FIG. 4 a and FIG. 4b) is provided in the gap between the inter shell and outer shell, to divide the gap into a plurality of gap spaces, the fourth hole 13a is provided on the outer shell 1a corresponding to each gap space, and is distributed within a preset range around the third hole 12a; the number of the fourth hole 13a is less than or equal to the number of the gap spaces. By the gap spaces and/or the fourth hole 13a, propagation path of the backward sound wave can be better controlled, so that the backward sound wave can be propagated in a more balanced and stable way, original characteristics of the backward sound wave of the loudspeaker can be better maintained and effects of high fidelity and high electroacoustic conversion efficiency can be achieved.

Further, the third hole 12a and the first hole 22a have an overlapped center, the third hole 12a has a bigger size than the first hole 22a, and a guide sheet 7 (as shown in FIG. 3) is provided on the periphery of the front side of the sound source 3 and projects towards the outer shell 1a. Setting the size of the third hole 12a bigger than the size of the first hole 22a can make the backward sound wave after reversing smoothly exit from the third hole 12a, and meanwhile the guide sheet 7 can avoid the backward sound wave exiting from the third hole 12a to interfere with the forward sound wave at the hole, and reduce sound quality. By isolating effect of the guide sheet 7, the backward sound wave and the forward sound wave pass along the guide sheet 7 and then meet each other, thereby realizing effective electroacoustic conversion effect, playing the maximum energy of vibration of a vibrating membrane such as a loudspeaker or drum membrane, and accurately reducing original quality of the sound source.

The sound generating device further comprises: a tone tuning layer (not shown in figures) that is attached onto at least one of the following positions (as shown in FIG. 2): the inner surface 24a of the inner shell 2a, the outer surface 21a of the inner shell 2a, and the inner surface 11a of the outer shell 1a. The tone tuning layer is a multilayer structure comprising at least one layer of tone tuning material, and a surface of the tone tuning layer may be provided with a groove. The shape of the groove can be designed according to acoustic characteristics of the sound enclosure. The tone tuning layer not only has a function of sound absorbing, but also has a function of regulating the backward sound wave, i.e., retaining the original characteristics of the backward sound wave more accurately through different ratios of sound absorption to reflection.

The sound generating device further comprises: a sound guide groove (not shown in the figures). The sound guide groove is provided at at least one of the following positions (as shown in FIG. 2): the inner surface 24a of the inner shell 2a, the outer surface 21a of the inner shell 2a, and the inner surface 11a of the outer shell 1a. Each surface of the above shells is provided with a groove for guiding propagation of a sound wave, i.e., a sound guide groove, and the sound guide groove may provide a professional propagation path for the sound wave, and then the sound wave propagates along the groove and meanwhile maintaining the original characteristics of the sound wave. It should be noted that the running of the sound guide groove can be designed by those skilled in the art, and this application does not have a limit on this.

The sound generating device further comprises: a guide block 8. The guide block 8 is arranged at each corner of the inner surface 24a of the inner shell 2a and/or each corner of the inner surface 11a of the outer shell 1a, and the shape of the guide block 8 is matched with each corner of the inner surface 24a of the inner shell 2a and/or each corner of the inner surface 11a of the outer shell 1a and has a concave arc surface. The guide block 8 can reduce reflection and collision between the backward sound wave and each corner of the inner surfaces of the inner and outer shells, so that the backward sound wave can smoothly flow along the arc surface of the guide block 8 into the guide channel of the backward sound wave, and thereby remain the original waveform characteristics of the backward sound wave so as to make the backward sound wave in the form of closest to its original state meet the forward sound wave.

In the sound generating device of the invention, by arranging the sound source in the sound generating device with an inter-outer shell structure, the backward sound wave of the sound source can pass through the hole provided on the inner shell and enter the gap between the inner shell and the outer shell, and then exit from the hole on the outer shell together with the forward sound wave of the sound source, thereby providing an unobstructed propagation path for the backward sound wave of the sound source. Such sound generating device completely subverts a design idea of the infinite baffle of a traditional sound generating device (such as a sound enclosure), i.e., a design idea of isolating the backward sound wave of the sound source, and thereby realizes effective utilization of the backward sound wave of the sound source. The present embodiment can maintain the original state of the backward sound wave as far as possible and make such backward sound wave meet the forward sound wave of the sound source, and thus high, medium and low voices of the sound source, such as loudspeaker, are released evenly without any repression. Low frequency that is different from the traditional sound enclosure largely depends on vibration amplitude of the loudspeaker diaphragm and reflection of the backward sound wave in the sound enclosure, while the high, medium, and low frequencies in the sound generating device of the present embodiment are complete reduction of the original high, medium, and low frequency sounds of the loudspeaker that is achieved by completely releasing sound waves emitted by the loudspeaker itself into the air by a reverse channel of the backward sound wave and then producing a physical effect with the forward sound wave. The sound generating device of the embodiment greatly improves the acoustic properties of the sound source, sound generating energy and electroacoustic efficiency of the sound source such as loudspeaker, sound generating efficiency of drum membrane or soundboard, having a great practical value.

### Embodiment 3

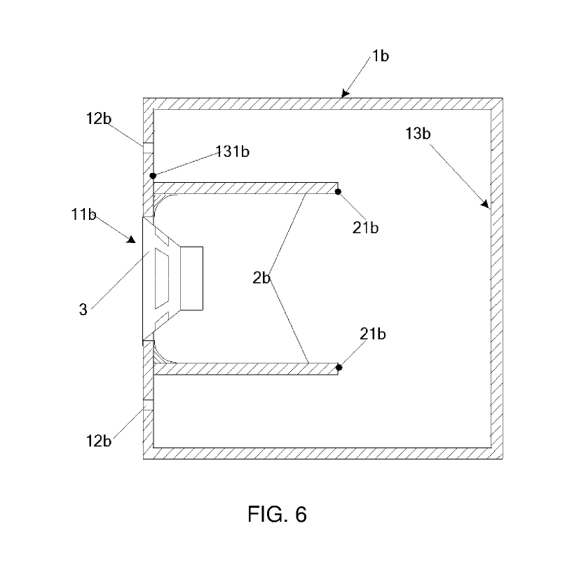

The present invention further provides another sound generating device, its acoustic principle is the same as the preceding embodiments, subverting design concept of infinite baffle in the prior art. By means of a special structure of the sound generating device, the backward sound wave of the sound source can be effectively utilized, and by reversing the backward sound wave and then interacting the backward sound wave with the forward sound wave of the sound source, the acoustic performance of the sound source can be improved. FIG. 6 is a structure diagram of another sound generating device provided by Embodiment 3 of the present invention. As shown in FIG. 6, the present invention provides another sound generating device, comprising a shell 1b, a sound source 3, at least one guide plate 2b; a fifth hole 11b and at least one sixth hole 12b are provided on the shell 1b, the sound source 3 is fixed within the fifth hole 11b, the sixth hole 12b is distributed around the fifth hole 11b within a preset range; each guide plate 2b is arranged on an inner surface of the shell 1b on the same side as the sound source 3 (i.e., the inner surface of the shell 1b on the side provided with the sound source 3, wherein the inner surface of the shell is labeled as 13b, and the inner surface of the shell on the same side as the sound source is labeled as 131b), and one end of the guide plate 2b is connected with the shell 1b, the other end of the guide plate 2b is a free end 21b, so that backward sound wave of the sound source 3 bypasses the free end 21b of the guide plate and exits from the sixth hole 12b.

The sound generating device shown in FIG. 6 has a specific structure as follows: a guide plate 2b is arranged within the shell 1b containing the sound source 3, and one end of the guide plate 2b is arranged on an inner surface 131b of the shell 1b on the same side as the sound source 3, and the other end of the guide plate 2b is a free end 21b, so that a backward sound wave emitted by the sound source 3 can bypass the free end 21b of the guide plate 2b, and exits from a sixth hole 12b preset on the shell 1b, the sixth hole 12b is located around the sound source 3 in a preset range, and cooperation between the guide plate 2b and the sixth hole 12b causes the backward sound wave of the sound source 3 to be reversed in the shell 1b along a space divided by the guide plate 2b, wherein the reversal of the backward sound wave is completed by a reverse channel, which also may be called as a guide channel, consisting of the shell 1b, the sixth hole 12b and the guide plate 2b, the guide channel can better control the propagation path of the backward sound wave so that the backward sound wave is reversed to form a “forward sound wave”, and then exits from the sixth hole 12b on the shell 1b, thereby enhancing radiation energy of the forward sound wave of the sound source 3.

In the sound generating device of the present embodiment, by setting the guide plate in the shell containing the sound source, with one end of the guide plate being provided on the inner surface of the shell on the same side as the sound source and the other end of the guide plate being a free end, the backward wave emitted by the sound source can bypass the free end of the guide plate and exit from the sixth hole preset on the shell, with the sixth holes being located around the sound source in a preset range. Such sound generating device provides an unobstructed propagation path for the backward sound wave of the sound source, completely subverts a design idea of the infinite baffle of a traditional sound generating device (such as a sound enclosure), i.e., a design idea of isolating the backward sound wave of the sound source, and thereby realizes effective utilization of the backward sound wave of the sound source by contrarily changing the direction of the backward sound wave and producing a physical effect with the forward sound wave of the sound source, thus the acoustic performance of the sound source is improved, such as, sound generating energy and electroacoustic efficiency of the loudspeaker, sound generating efficiency of the drum membrane or soundboard, are greatly improved, bringing about a great practical value.

### Embodiment 4

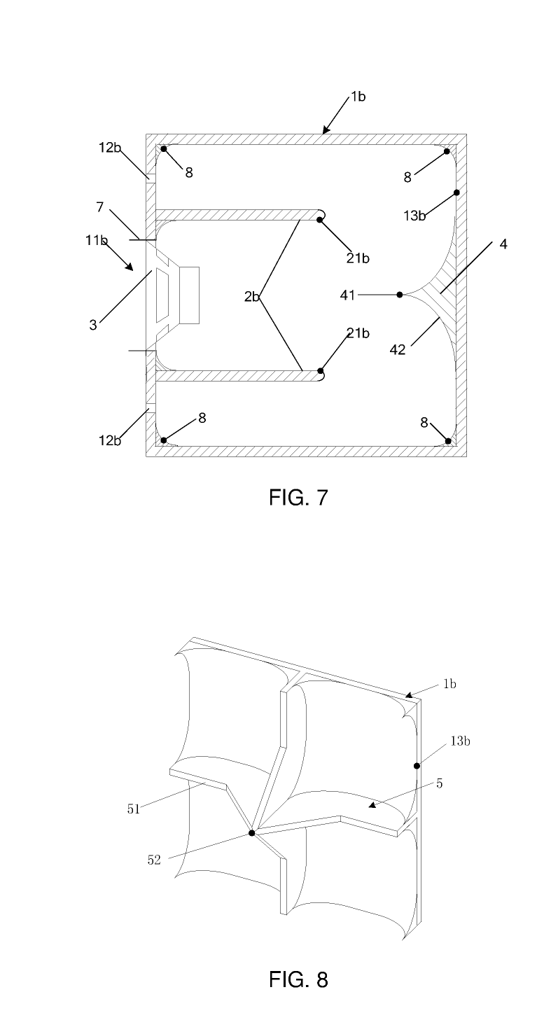

FIG. 7 is a structure diagram of another sound generating device provided by Embodiment 4 of the present invention. As shown in FIG. 7, the present invention provides a sound generating device based on Embodiment 3, wherein the free end 21b of the guide plate 2b is an arc-shaped structure. The arc-shaped structure can make the backward sound wave of the sound source 3 bypass the free end 21b of the guide plate 2b as smoothly as possible, remaining the original waveform characteristics of the backward sound wave to a maximum extent, and making the backward sound wave in the form of closest to the original state meet the forward sound wave.

The sound generating device further comprises: a guide block 8. The guide block 8 is arranged at each corner of the inner surface 13b of the shell, and the shape of the guide block 8 is matched with each corner of the inner surface 13b of the shell and has a concave arc surface. The guide block 8 can reduce reflection and collision between the backward sound wave and each corner of the inner surface 13b of the shell, so that the backward sound wave can smoothly flow along the arc surface of the guide block 8 into the guide channel of the backward sound wave, the guide channel is composed of the sixth hole 12b, the guide plate 2b, and the shell 1b in accordance with structural space principle of acoustics, so that the backward sound wave can remain its original waveform characteristics as far as possible and thus the backward sound wave in the form of closest to the original state meet the forward sound wave.

Further, the shell 1b can be a polyhedron, for example, cube shell 1b shown in FIG. 7; the shell also can be a sphere, an ellipsoid, or the shell is a shell that the inner surface 13b is a curved surface and the outer surface is a polyhedron.

Specifically, if the shell 1b is a polyhedron, the reflection and collision between the backward sound wave and each corner of the inner surface 13b of the shell can be reduced in a way of disposing the guide block 8 at each corner of the inner surface 13b of the shell, so that the backward sound wave can smoothly flow along the arc surface of the guide block 8 into the guide channel of the backward sound wave. Through the provision of the guide block 8, it is possible to avoid destruction of each corner of the polyhedral shell 1b on the back sound wave, so as to remain the original waveform characteristics of the backward sound wave as far as possible. If the shell 1b is a sphere, an ellipsoid, the shell 1b with the arc surface structure is not to be easily placed on a table smoothly, and in this case, the shell 1b can be designed as such a shell that the inner surface 13b is a curved surface and the outer surface is a polyhedron, so that the backward sound wave can not only be reversed smoothly within the curved inner surface of the shell 1b, but also enable the shell 1b to be placed easily and stably.

The sound generating device further comprises: a partial tone cone 4. The partial tone cone 4 is a conical structure and is fixed on the inner surface 13b of the shell 1b, and a conical tip 41 of the partial tone cone 4 is opposite to a fifth hole 11b. The partial tone cone 4 can reduce direct collision between the backward sound wave and the inner surface 13b of the shell 1b and reduce a probability of vertical reflection, so as to reduce the interference on the original sound wave waveform and make the backward sound wave smoothly flow along the conical tip 41 of the partial tone cone 4 into the guide channel of the backward sound wave, remaining the original waveform characteristics of the backward sound wave to a maximum extent, and making the backward sound wave in the form of closest to the original state meet the forward sound wave. In order to further reduce the reflection of the backward sound wave and prevent generation of a standing wave from and meanwhile to remain complete sound wave characteristics as far as possible, the conical side surface 42 of the partial tone cone 4 can be designed to be a concave conical side surface 42.

In addition, the sound generating device may comprises (as shown in FIG. 8, FIG. 8 is a structure diagram of a partial tone plate of another sound generating device provided by Embodiment 4 of the present invention): a partial tone plate 5. The partial tone plate 5 has the same function as the partial tone cone 4, i.e., enable sound wave to more smoothly enter into the reverse channel of the sound wave. The partial tone plate 5 is a star shaped rib 51 and is fixed on the inner surface 13b of the outer shell 1b, and a center 52 of the partial tone plate 5 is opposite to the fifth hole 11b, and the rib 51 of the partial tone plate 5 faces towards the fifth hole 11b. In order to further reduce the reflection of the backward sound wave and prevent generation of a standing wave, and meanwhile remain complete sound wave characteristics as far as possible, the rib 51 of the partial tone plate 5 can be designed as a concave structure.

Further, a projecting guide sheet 7 is provided on the periphery of the front side of the sound source 3. The guide sheet 7 has a function of isolation so that the backward sound wave and the forward sound wave pass along guide sheet 7 and then meet each other, thereby reducing the mutual interference between the backward sound wave and the forward sound wave when the backward sound wave just exits from the sixth hole 12b. Meeting of the backward sound wave and the forward sound wave in the air can enhance electroacoustic conversion effect, and play the maximum energy of the vibration of the vibrating membrane, such as loudspeaker, and accurately reduce the original quality of the sound source.

The sound generating device further comprises: a tone tuning layer (not shown in the figures). The tone tuning layer is attached onto at least one of the following positions: the inner surface 13b of the shell, a surface of the guide plate 2b, the concave arc surface of the guide block 8. The tone tuning layer is a multilayer structure comprising at least one layer of tone tuning material, and a surface of the tone tuning layer may be provided with a groove. The shape of the groove can be designed according to acoustic characteristics of the sound enclosure. The tone tuning layer not only has a function of sound absorbing, but also has a function of regulating the backward sound wave, i.e., retaining the original characteristics of the backward sound wave more accurately through different ratios of sound absorption to reflection.

Further, on the basis of each embodiment above, the sound generating device further comprises: a sound guide groove (not shown in the figures). The sound guide groove is provided at at least one of the following positions: the inner surface 13b of the shell, a surface of the guide plate 2b and the concave arc surface of the guide block 8. Each surface of the above shells is provided with a groove for guiding propagation of a sound wave, i.e., a sound guide groove, and the sound guide groove may provide a professional propagation path for the sound wave, and then the sound wave propagates along the groove, thereby improving the smoothness of sound wave propagation. It should be noted that the running of the sound guide groove can be designed by those skilled in the art, and this application does not have a limit on this.

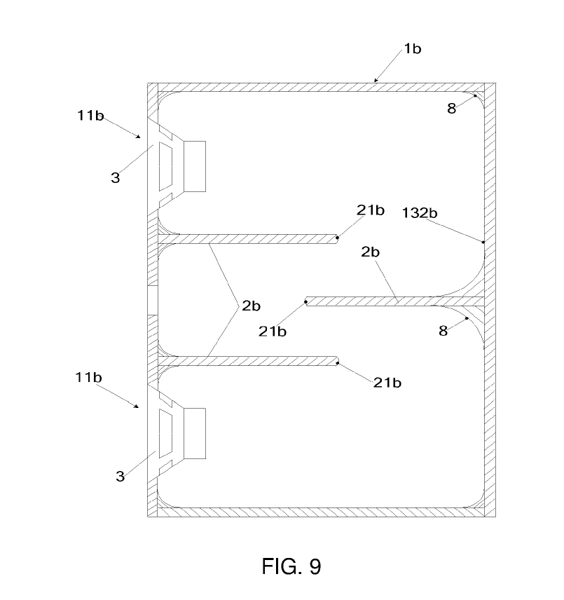

Further, as shown in FIG. 9 which is a structure diagram of multiple sound sources of another sound generating device provided by Embodiment 4 of the present invention. As shown in this Figure, at least two fifth holes 11b are provided on the shell 1b, a sound source 3 is fixedly provided in each of the fifth holes 11b. At least one guide plate 2b is provided on an inner surface 132b of the shell facing the back side of the sound source 3; and an free end 21b of the guide plate 2b is opposite to a sixth hole 12b. A single sound source, such as a loudspeaker, has limited sound generating power, and by synergistic effect of the forward sound wave and the backward sound wave of the loudspeaker, power endurance of the sound enclosure can be greatly improved, so that sound analysis capability and energy performance of the sound enclosure is greatly improved without increasing vibration amplitude of the loudspeaker diaphragm. For the at least one guide plate 2b that is provided on an inner surface 132b of the shell facing the back side of the sound source 3, the guide plate 2b can also be replaced by the partial tone plate 5 as shown in FIG. 8 or the partial tone cone 4 as shown in FIG. 7.

In the sound generating device of the present embodiment, the provision of the guide plate, the guide block, the partial tone cone, the partial tone plate, etc. can enable the backward sound wave of the sound source to remain original characteristics of the sound wave as far as possible, smoothly pass through spaces divided by the guide plate, and then exit from the sixth hole of the shell, thereby providing an unobstructed propagation path for the backward sound wave of the sound source. Such sound generating device completely subverts a design idea of the infinite baffle of a traditional sound generating device (such as a sound enclosure), i.e., a design idea of isolating the backward sound wave of the sound source, and thereby realizes effective utilization of the backward sound wave of the sound source and can maintain the original state of the backward sound wave, and make such backward sound wave meet the forward sound wave of the sound source, and thus a full frequency sound source, i.e., high, medium and low voices of such as a loudspeaker, are released evenly without any repression. Low frequency that is different from the traditional sound enclosure largely depends on vibration amplitude of the loudspeaker diaphragm and reflection of the backward sound wave in the sound enclosure, while the high, medium, and low frequencies in the sound generating device of the present embodiment are complete reduction of the original high, medium, and low frequency sounds of the loudspeaker that is achieved by completely releasing sound waves emitted by the loudspeaker itself into the air by a reverse channel of the backward sound wave and then producing a physical effect with the forward sound wave after meeting the forward sound wave. The sound generating device of the embodiment greatly improves the acoustic properties of loudspeaker, sound generating efficiency of drum membrane or soundboard, and sound generating energy and electroacoustic efficiency of the loudspeaker, having a great practical value.

The present invention further provides a terminal comprising: a terminal body; the sound generating device of, for example, Embodiment 1 or Embodiment 2, or the sound generating device of, for example, Embodiment 3 or Embodiment 4 is provided at a receiver of the terminal body. The terminal includes: mobile phones, notebooks, tablet PCs, POS machines, on-board computers and other electronic devices.

It should be understood by those skilled in the art that all or part of steps of above method embodiments can be completed by a program instruction related hardware, and the program can be stored in a computer readable storage medium, and when performing the program, the steps included in above method embodiments can be performed; and the storage medium includes: ROM, RAM, magnetic disc or compact disc and other medium that can store program codes.

Finally, it should be noted that the above embodiments is only to illustrate the technical solutions of the present invention, rather than to limit it; although the invention has been described in detail with reference to the aforementioned embodiments, it should be understood for those skilled in the art that modifications of the technical solutions recorded in the above embodiments, or equivalent replacements of part or all of the technical features in the embodiments can be made; these modifications or replacements will not make the essence of corresponding technical solutions depart from the scope of the technical solutions of the embodiments of the present invention.

What is claimed is:

1. A sound generating device, comprising: an outer shell, an inner shell, a sound source, wherein the inner shell is provided inside the outer shell, a gap is formed between a outer surface of the inner shell and a inner surface of the outer shell;
a first hole and a second hole opposite to each other are provided on the inner shell; the sound source is fixed inside the first hole, and a front side of the sound source faces towards the outer shell, and a back side of the sound source faces towards the second hole;
a third hole opposite to the first hole is provided on the outer shell, and is spaced apart from the sound source by a distance; a backward sound wave of the sound source passes through the second hole and enters into the gap, and then exits from the third hole together with the forward sound wave of the sound source.

2. The sound generating device according to claim 1, wherein the inner shell and the outer shell have identical shape.

3. The sound generating device according to claim 2 further comprising: a guide block, wherein the guide block is provided at each corner of the inner surface of the inner shell and/or each corner of the inner surface of the outer shell, and the guide block has a shape that is matched with the each corner of the inner surface of the inner shell and/or the each corner of the inner surface of the outer shell, and has a concave arc surface.

4. The sound generating device according to claim 3, wherein the inner shell and the outer shell are polyhedrons, and gravity centers of the inner shell and the outer shell are overlapped.

5. The sound generating device according to claim 2, wherein the inner shell and the outer shell are spheres, and sphere centers of the inner shell and the outer shell are overlapped.

6. The sound generating device according to claim 1 further comprising a partial tone cone, wherein the partial tone cone is a cone structure and is fixed on the inner surface of the outer shell, and a conical tip of the partial tone cone is opposite to the second hole.

7. The sound generating device according to claim 6, wherein a conical side surface of the partial tone cone is concave.

8. The sound generating device according to claim 1 further comprising: a partial tone plate, wherein the partial tone plate is a star shaped rib and is fixed on the inner surface of the outer shell, a center of the partial tone plate is opposites to the second hole, and the rib of the partial tone plate faces to the second hole.

9. The sound generating device according to claim 8, wherein the rib of the partial tone plate is concave.

10. The sound generating device according to claim 1, wherein at least one gap partition plate is provided within the gap to divide the gap into a plurality of gap spaces.

11. The sound generating device according to claim 10, wherein a fourth hole is provided on the outer shell corresponding to each of the gap spaces and is distributed around the third hole within a preset range, and the number of the forth hole is less than or equal to the number of the gap spaces.

12. The sound generating device according to claim 1, wherein centers of the third hole and the first hole are overlapped, the third hole has a bigger size than the first hole, and a guide sheet is provided on the periphery of the front side of the sound source and projects towards the outer shell.

13. The sound generating device according to claim 1 further comprising:
a tone tuning layer, wherein the tone tuning layer is attached onto at least one of the following positions:
the inner surface of the inner shell, the outer surface of the inner shell, and the inner surface of the outer shell.

14. The sound generating device according to claim 13, wherein the tone tuning layer is a multilayer structure comprising at least one layer of tone tuning material, and a surface of the tone tuning layer is provided with a groove.

15. The sound generating device according to claim 1 further comprising: a sound guide groove, wherein the sound guide groove is provided at at least one of the following positions:
the inner surface of the inner shell, the outer surface of the inner shell, and the inner surface of the outer shell.

16. The sound generating device according to claim 1, wherein the sound generating device is a sound enclosure, an earphone or a musical instrument.

17. The sound generating device according to claim 1, wherein the sound source is a loudspeaker, a drum membrane, or a soundboard.

18. A sound generating device, comprising: a shell, a sound source, at least one first guide plate;
a fifth hole and at least one sixth hole are provided on the shell, the sound source is fixed within the fifth hole, and the sixth hole is distributed around the fifth hole within a preset range;
each guide plate is arranged on an inner surface of the shell on the same side as the sound source, and one end of the guide plate is connected with the shell and the other end of the guide plate is a free end, so that a backward sound wave of the sound source bypasses the free end of the guide plate and exits from the sixth hole.

19. The sound generating device according to claim 18, wherein the free end of the guide plate is an arc-shaped structure.

20. The sound generating device according to claim 19 further comprising: a guide block, wherein the guide block is arranged at each corner of the inner surface of the shell, has a shape that is matched with each corner of the inner surface of the shell, and has a concave arc surface.

21. The sound generating device according to claim 20, wherein the shell is a polyhedron.

22. The sound generating device according to claim 19, wherein the shell is a sphere, an ellipsoid, or the shell is such a shell that the inner surface thereof is a curved surface and the outer surface thereof is a polyhedron.

23. The sound generating device according to claim 18 further comprising: a partial tone cone, wherein the partial tone cone is a conical structure and is fixed on the inner surface of the shell, and a conical tip of the partial tone cone is opposite to the fifth hole.

24. The sound generating device according to claim 23, wherein a conical side surface of the partial tone cone is concave.

25. The sound generating device according to claim 18 further comprising: a partial tone plate, wherein the partial tone plate is a star shaped rib and is fixed on the inner surface of the shell, a center of the partial tone plate is opposite to the fifth hole, and the rib of the partial tone plate faces to the fifth hole.

26. The sound generating device according to claim 23, wherein the rib of the partial tone plate is concave.

27. The sound generating device according to claim 18, wherein a projecting guide sheet is provided on the periphery of the front side of the sound source.

28. The sound generating device according to claim 20 further comprising: a tone tuning layer; wherein the tone tuning layer is attached onto at least one of the following positions:
the inner surface of the shell, a surface of the guide plate, the concave arc surface of the guide block.

29. The sound generating device according to claim 28, wherein the tone tuning layer is a multilayer structure comprising at least one layer of tone tuning material, and a surface of the tone tuning layer is provided with a groove.

30. The sound generating device according to claim 18 further comprising: a sound guide groove; wherein the sound guide groove is provided at at least one of the following positions:
the inner surface of the shell, a surface of the guide plate, the concave arc surface of the guide block.

31. The sound generating device according to claims 18, wherein at least two fifth holes are provided on the shell, and each of the fifth holes is provided with the sound source.

32. The sound generating device according to claim 31, wherein at least one guide plate is provided on the inner surface of the shell facing a back side of the sound source; and the free end of the guide plate is opposite to the sixth hole.

33. The sound generating device according to claim 18, wherein the sound generating device is a sound enclosure, an earphone or a musical instrument.

34. The sound generating device according to claim 18, wherein the sound source is a loudspeaker, a drum membrane, or a soundboard.

35. A terminal comprising: a terminal body, wherein the sound generating device according to claim 1, or the sound generating device according to claim 18 installed, is arranged at a receiver of the terminal body.
